(19) United States
(12) Patent Application Publication
(10) Pub. No.: US 2020/0055579 A1
(43) Pub. Date: Feb. 20, 2020

(54) BOAT LIFT SYSTEMS AND METHODS

(71) Applicant: WP Controls, LLC, Gravois Mills, MO (US)

(72) Inventors: Timothy L. Wright, Warrensburg, MO (US); Robert P. Peters, Knob Noster, MO (US)

(21) Appl. No.: 16/543,489

(22) Filed: Aug. 16, 2019

Related U.S. Application Data
(60) Provisional application No. 62/719,025, filed on Aug. 16, 2018.

(51) Int. Cl. B63C 1/06; G05D 3/20

(52) U.S. Cl. CPC B63C 1/06; G05D 3/20

(57) ABSTRACT

The present invention relates to improved lifts and lift systems, as well as the associated methods of use, for raising and lowering watercraft into and out of water.

### BACKGROUND OF THE INVENTION

### A. Field of the Invention

The present invention relates to improved lift systems, as well as the associated methods of use, for raising and lowering watercraft into and out of water.

### B. Description of the Related Art

A variety of boatlifts and lifting systems have been devised to raise or lower watercraft to desired heights for use, loading, or storage. These systems vary in their ease of use, maintenance requirements, and suitability to different environmental conditions. Additionally, existing boatlifts and lifting systems generally require that a user park a watercraft and step out of it onto a dock in conditions where the watercraft is apt to be at a less than optimal height for disembarking or boarding.

The present invention has been developed to provide an improved watercraft lifting system for raising and lowering watercraft to different positions relative to the water and associated dock or other structure. The present invention provides several advantages over current lift systems.

### SUMMARY OF THE INVENTION

The present invention provides a system that integrates newer technologies and desirable features into a boatlift system such that, as a whole, the system is improved and one or more technical limitations of current boatlifts are overcome. In particular, the present invention eliminates the need for certain manual maintenance and replaces it with automated maintenance that is considered to be safer and less cumbersome.

Advantageously, systems of the present invention can be operated remotely. Such remote operation is considered to be both safer and more convenient especially during, or in preparation for, inclement weather conditions.

The present invention provides improved boatlift systems that allow an operator (user) to program and customize a lift's positions and to better maintain or adjust a watercraft's position on a lift relative to the water level even when the water level varies unpredictably. Those of skill in the art will appreciate that the ability to automatically or remotely adjust a lift's height will reduce the amount of time that a user must spend on-site making such adjustments. Further, when inclement weather causes unexpected changes in a lift's height relative to the water level, the invention can automatically adjust the lift's height to accommodate the unexpected changes. Advantageously, the invention provides means of informing a user of any such height adjustments.

The invention reduces, or even eliminates, certain necessary manual maintenance that is commonly associated with current pressure (or height) sensors on lift systems. Specifically, the invention eliminates the necessity of manually clearing debris away from a water intake opening of a pressure (or height) sensor when the sensor, or at least its intake opening, is submerged. Instead, the invention provides an automated means or removing such debris, and advantageously eliminates the need for manual removal of the debris.

An improvement of the invention is to automatically direct the removal of any residual water or debris that could interfere with accurately measuring a lift's height by forcing air from a blower within the controller through a small air tube into a rigid tube and out its open end such that any water or debris inside the rigid tube is purged. By using air to reverse the pressure inside the rigid tube and blow air out of the rigid tube's open end, any debris that may cover the open end is pushed away. Thus, the open end is not covered and an accurate pressure reading can be made. Advantageously, by removing any residual water from within the rigid tube, the effective life of the pressure sensor may be increased.

Those of skill in the art will appreciate that by automating this feature a user does not need to attempt to manually work on a submerged component(s) or to raise a component(s) out of the water to clear debris away. Further, this feature of the invention can be used repeatedly in rapid succession to maintain a clear open end so that accurate pressure readings can be made. The skilled artisan will recognize that in turbulent water a sensor's intake opening can be repeatedly blocked to cause repeated errors in measuring pressure, and thereby repeated errors of the height of a lift and its associated watercraft.

By clearing or maintaining a clear opening to the rigid tube, inaccurate readings can be reduced or even eliminated. Those of skill in the art will appreciate the advantages of having accurate pressure readings, especially when a user wishes to remotely monitor the status of a lift, and any associated watercraft.

With a floating lift, the rigid tube is mounted on the lift, and pressure changes within the rigid tube correlate with the lift being raised or lowered in the water. With either a suspended or bottom standing lift, the rigid tube can be mounted onto a suspended or bottom standing lift frame or attached to such lifts by the use of a pulley system (e.g. block and tackle, rope and pulley, or other hoist) or other suitable mechanisms known in the art. Advantageously, the rigid tube can be placed in a variety of positions on a lift or lift frame so that a lift's height relative to the water surface can be ascertained.

The rigid tube is preferably composed of polyvinyl chloride (PVC) plastic or another lightweight plastic or resin that is flexible and suitable for use in aquatic environments. It is expected that most materials suitable for the construction of plumbing pipe or water hoses would be suitable for constructing the air tube.

An improvement that the present invention provides is that erratic pressure readings can be eliminated and associated sensor malfunctions reduced or eliminated. The invention provides for the controlled removal of residual water from the rigid tube after operation. By purging residual water from the rigid tube, erratic or false pressure readings can be eliminated and associated sensor malfunctions are reduced or eliminated.

Besides providing improved height sensors and a means of automating the maintenance of these height sensors, the invention also provides improved systems by which a person can operate a lift.

Systems of the invention include using a controller. The controller is an apparatus that is preferably located on the dock or pier adjacent to the lift. The controller is programmable and includes an input-output mechanism, such as a touch screen or analogous display or interface, by which a user can operate and program a lift to maintain a specified height relative to the water level.

Advantageously, the controller input-output mechanism can display a lift's current position relative to the water level. This input-output mechanism provides a means for a user to program and save preferred lift positions. A user may select and save multiple storage positions, boarding positions, and operating positions. Herein, an operating position is the lowered lift position that allows a watercraft to be freed from the lift and operate in the water.

Systems of the invention allow a user to calibrate custom lift positions so that boarding can be accomplished more easily and safely. Using sensor data, multiple, custom, lift positions for boarding a variety of watercraft can be calibrated, then entered and saved via the controller's input-output mechanism. The controller can then adjust a lift's position, and thereby adjust the position of a specified watercraft on the lift, to an optimum stable position so that boarding can be easily and safely accomplished.

Such versatility allows a single lift to be used for multiple watercraft or operations. For example, a user may choose a first boarding position for a boat lacking a payload and a second boarding position for a boat carrying a full payload. Similarly, a user may choose a first boarding or operation position for one type of watercraft and a second boarding or operation position for a second type of watercraft. Those of skill in the art will appreciate that preferred operating positions can vary from watercraft to watercraft and preferred boarding positions can vary from user to user.

Additionally, embodiments of the invention that are suitable for floating lifts can be programmed to allow for a specified amount of time to bubble the lift's tanks after the up (storage) position is achieved to ensure that the lift, as well as any associated watercraft, is maintained at a desired position.

Preferred embodiments of the invention include systems that are compatible with a mobile device application or other computing device so that a user can remotely operate the systems and receive alerts and status updates remotely. These preferred embodiments provide a user with access to a lift's data and allow a user to remotely operate a lift through the controller.

The invention provides improved boatlift systems that comprise a controller having an air manifold, a microprocessor having a pressure sensor, and a blower motor. The blower motor is attached to a first end of a blower hose, and the second end of the blower hose is attached to a purge hose. The microprocessor is attached to a near end of a small air hose that is coupled to the purge hose. A purge valve is attached to the purge hose between the blower hose and small air hose. The invention further includes an input-output mechanism that is able to transmit and receive a signal; and a rigid tube that is attached vertically to a boatlift or boatlift frame. The rigid tube has an upper end that is sealed and a lower end that is open. The rigid tube is coupled to the far end of the small air hose such that when the boatlift or boatlift frame is lowered into water the open end of the rigid tube is submerged in the water.

The microprocessor sends and receives input from the purge valve.

Preferably, a first electric ball valve is attached to the blower hose.

The improved boatlift systems of the invention further include a passive vent hose that is attached to the air manifold, as well as, an active vent hose that is also attached to the air manifold. A manual ball valve is attached to the passive vent hose. A second electric ball valve is attached to the active vent hose.

In systems of the invention that are attached to a boatlift frame, a large air hose is attached to the air manifold.

The invention also provides for methods of making an improved boatlift system. These methods comprise (a) constructing a controller having an air manifold, a microprocessor, and a blower motor that is attached to a first end of a blower hose, wherein the second end of the blower hose is attached to a purge hose, and the microprocessor is attached to a near end of a small air hose that is coupled to the purge hose, and wherein a purge valve is attached to the purge hose between the blower hose and small air hose; (b) attaching an input-output mechanism that is able to transmit and receive a signal to the controller; and (c) attaching a rigid tube vertically to a boatlift or boatlift frame, wherein the rigid tube has an upper end that is sealed and a lower end that is open, and the rigid tube is coupled to the far end of the small air hose.

Further, the invention provides methods of using improved boatlift systems. Such methods comprise (a) programming a controller that includes a microprocessor to direct a boatlift or boatlift frame to rise or descend to one or more specified heights relative to a body of water; (b) using a sensor to measure air pressure in a small air hose that has a far end attached to a rigid tube, wherein the rigid tube has a sealed upper end, an open lower end, and is attached vertically to the boatlift or boatlift frame such that when the boatlift or boatlift frame is lowered into the body of water, water enters the open lower end of the rigid tube, and air pressure in the small air hose equals the air pressure within the rigid tube; and (c) operating the controller to raise or lower the boatlift or boatlift frame to a programmed height.

Methods of using the improved boatlift systems of the invention further comprise purging water from the rigid tube by blowing air into the rigid tube through the small air hose, wherein the small air hose has a near end coupled to a blower hose that is connected to a blower such that when the controller directs a purge valve to open, air from the blower is forced through the small air tube into the rigid tube, and any water within the rigid tube is forced from the rigid tube through its lower end.

Other objects, features and advantages of the present invention will become apparent from the following detailed description. It should be understood, however, that the detailed description and the specific examples, while indicating preferred embodiments of the invention, are given by way of illustration only, since various changes and modifications within the spirit and scope of the invention will become apparent to those skilled in the art from this description.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 illustrates the relative positions of a boat, lift, and lift controller to a dock in the boarding position where the dashed line indicates the water line.

FIG. 2 illustrates the relative positions of a boat, lift, and lift controller to a dock when the lift is in the down or water position where the dashed line indicates the water line.

FIG. 3 illustrates the relative positions of a boat, lift, and lift controller to a dock when the lift is in the up or storage position where the dashed line indicates the water line.

FIG. 4 shows different exterior views of a lift controller housing or enclosure. FIG. 4A is a top view. FIG. 4B is a front view. FIG. 4C is a side view where both sides are identical in appearance. FIG. 4D is a back view.

FIG. 5 is an electrical diagram for a lift controller. Solid lines represent 120 volt AC power, neutral, and ground connections as respectively indicated. Dashed lines represent 5 volt DC connections. Dot-dash lines represent 24 volt DC connections.

FIG. 6 is a block diagram illustrating the power and signal relationships between a controller, blower motor, purge solenoid, and various sensors. Solid lines represent power connections; dashed lines represent signal connections.

FIG. 7 illustrates the relationships of the interior components of a controller.

FIG. 8 is a block diagram illustrating the process to move the lift to the up position.

FIG. 9 is a block diagram illustrating the process to move the lift to the down position.

FIG. 10 is a block diagram illustrating the process to move the lift to the boarding position.

FIG. 11 is a block diagram illustrating the auto height monitor mode process.

FIG. 12 is a block diagram illustrating the lift controller programmable receptacle process for monitoring ambient light using a light sensor.

FIG. 13 is a block diagram illustrating the lift controller programmable receptacle process for monitoring the temperature.

FIG. 14 is a block diagram illustrating the lift controller programmable receptacle process for programming a preferred schedule using an electrical receptacle as an example.

### DETAILED DESCRIPTION

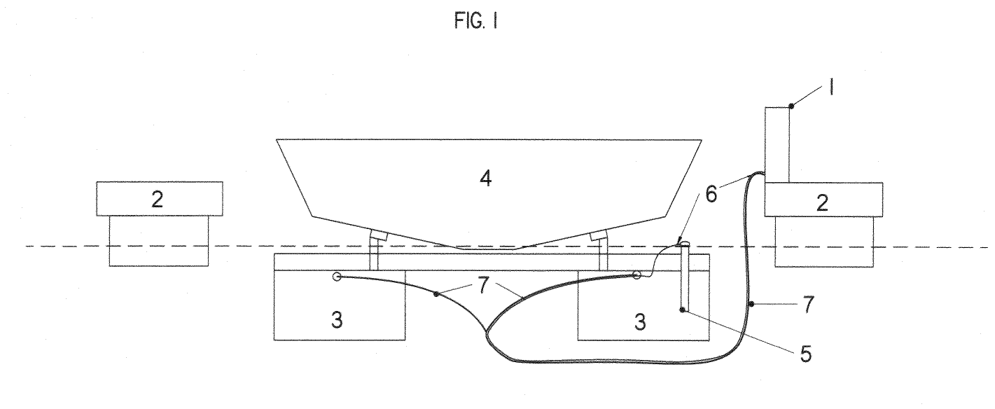

Systems of the present invention can be integrated with all types of boatlifts (i.e. floating, suspended, and bottom standing boatlifts). Those of skill in the art will appreciate that the systems provided by the invention solve problems that are most often encountered in environments in which floating boatlifts are used. Thus, for illustrative purposes and better clarity, the invention is illustrated as part of a floating boatlift in accompanying FIGS. 1-3. Changes in the operation of the invention or the systems of the invention with other types of lifts (i.e. suspended or bottom standing) are noted and described herein. For reference and illustrative purposes, general representations of a dock 2, lift 3, and boat 4 are provided to better explain the claimed invention. Because the exemplary lift 3 is a floating lift, a lift fill hose 7 is also indicated in FIGS. 1-3. Those of skill in the art will appreciate that each of these articles comprises multiple parts that can vary depending upon its environment and a user's objectives.

The present invention provides improved boatlift systems that allow an operator (user) to customize lift positions and to better maintain or adjust a watercraft's position on a lift relative to the water level even when the water level varies unpredictably. The invention reduces, or even eliminates, sensor malfunctions that are associated with a sensor's exposure to water or the environment and that prevent watercraft from being maintained at a desired position relative to the water level. Advantageously, the invention allows a user to operate a boatlift and to maintain a watercraft's relative position remotely.

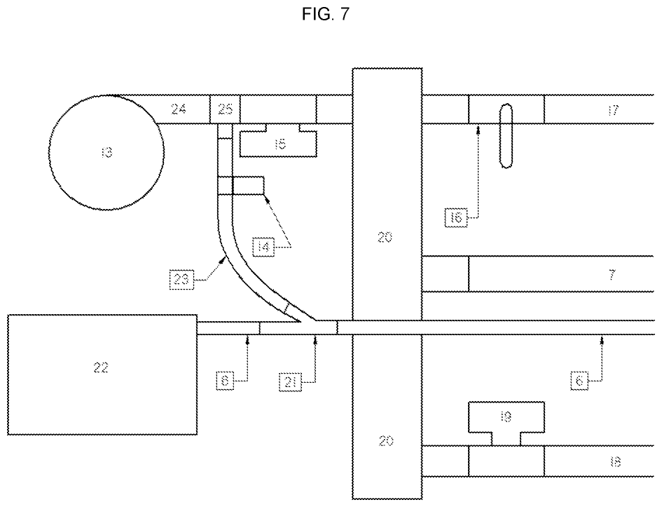

To adjust a lift's position, and thereby a watercraft's position, the invention provides a controller 1. Internally, the controller 1 includes an air manifold 20, a blower motor 13, a blower hose 24 with an electric ball valve 15 (i.e. a first electric ball valve) and a coupler 25 (i.e. a first coupler), a purge hose 23 with a purge valve 14 (also referred to herein as a purge solenoid or a solenoid valve) and a coupler 21 (i.e. a second coupler), a passive vent hose 17 with a manual ball valve 16, a small air hose 6, a regular (active) vent hose 18 with an electric ball valve 19 (i.e. a second electric ball valve), and a microprocessor 22. A controller that operates a floating lift also includes a large air hose 7. See FIG. 7.

Those of skill in the art will be familiar with the general operation of automated lift systems and floating lift systems. In particular, the skilled artisan will appreciate that air pressure is used to raise and lower floating lifts. In the present invention, during normal (i.e. powered) operation the first electric ball valve 15 is opened so that air flows from the blower motor 13 through the blower hose 24 into the air manifold 20 and through the large air hose 7 to pump air into a lift's air tanks to raise the lift. To lower the lift, the second electric ball valve 19 is opened so that air escapes from the lift's tanks back through the large air hose 7 into the air manifold 20 and out the regular (active) vent hose 18 to the external environment. During manual operation (i.e. the blower motor is not operated), a lift can be lowered by manually opening the manual ball valve 16 so that air can flow from a lift's tanks through the large air hose 7 into the air manifold 20 and out the passive vent hose 17.

The small air hose 6, passive vent hose 17, large air hose 7, and regular (active) vent hose 18 extend externally from the controller. The passive vent hose 17 and regular (active) vent hose 18 are relatively short and extend by at least about 1 inch to 6 inches, preferably by about a foot, more preferably by 2 feet, 3 feet, or more into the external environment. The exterior (far) ends of both of these hoses are sufficiently open so that air can be vented through them.

All of the air hoses are flexible hoses or tubes. Preferably, these hoses are resistant to degradation in outdoor environments. More preferably, these hoses are composed of flexible hosing or tubing that is resistant to degradation from temperature fluctuation, water, especially saltwater, and sunlight. The small air hose 6 may be composed of any air hose having a relatively small interior diameter that can be attached to the rigid tube 5 and the controller 1. Preferred small air hoses have a relatively small interior diameter (e.g. less than one-inch and greater than 0.123 inches). The interior diameters of other hoses in the invention are generally larger than that of the small air hose 6. Those of skill in the art will appreciate that the sizes of the hoses will be influenced by the rate at which air moves through the hoses, their overall lengths, and the environment.

The near end of the small air hose 6 attaches to the microcontroller 22. It may attach directly to the microprocessor 22, or alternatively, a suitable coupler may be used to attach the small air hose 6 to the microprocessor 22. The far end of the small air hose 6 attaches, either directly or with a coupler, to a rigid tube 5 that is attached to the lift 3. See FIGS. 1-3. Alternatively, the rigid tube 5 can be attached to a lift's supporting frame or other structure that is raised and lowered into the water as the lift is also raised and lowered.

This rigid tube 5 has an open end and a closed end. The rigid tube 5 is oriented vertically such that its open end is directed downward, and its closed end is pointed upward. The upper end of the rigid tube 5 may be closed by a variety of suitable means that are known in the art. It is only necessary that the means chosen to close (or seal) the upper end results in a sufficiently airtight seal so that when the open end of the rigid tube 5 is submerged in water, air is trapped within the rigid tube 5.

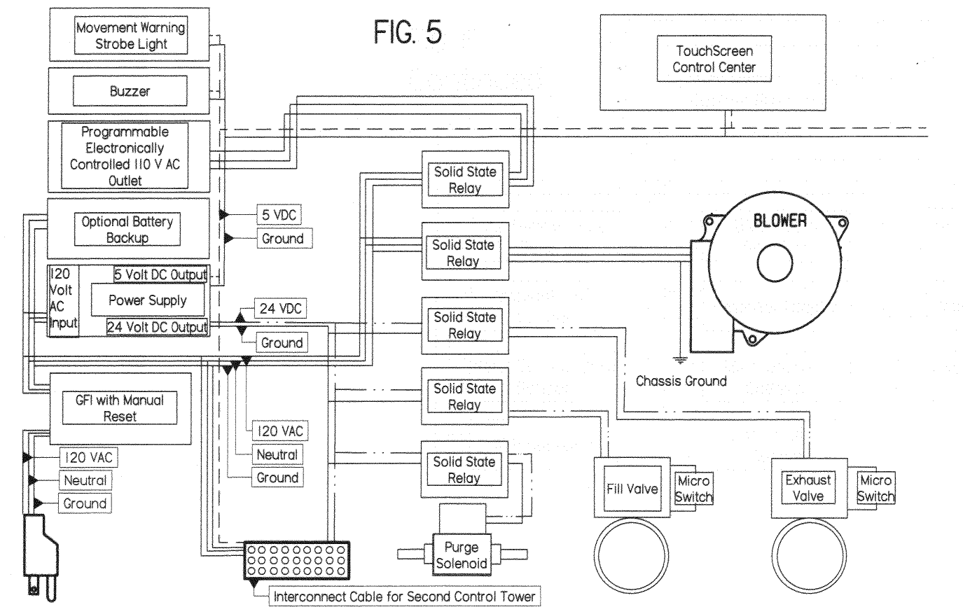

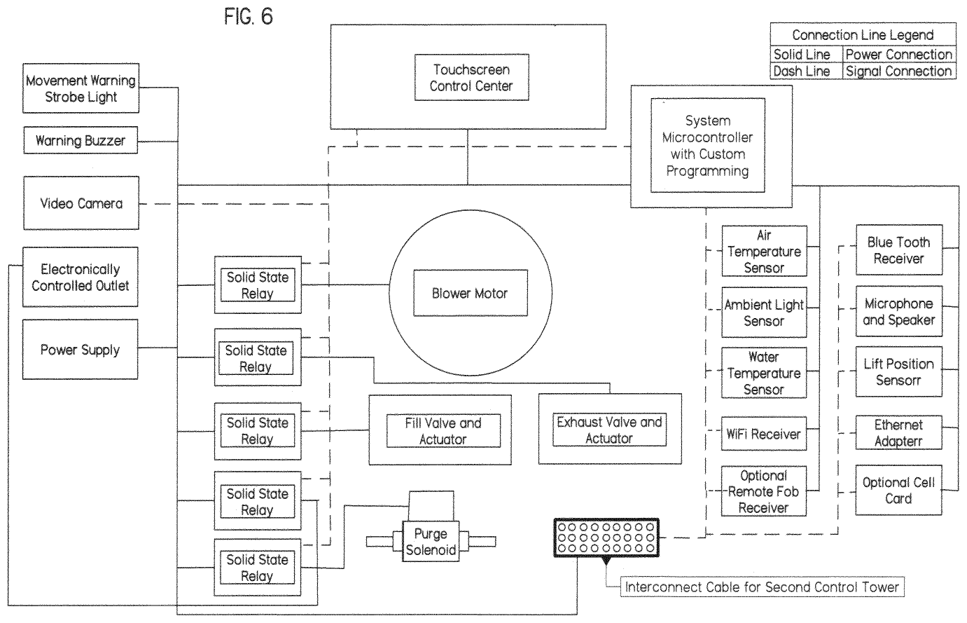

The microprocessor 22 comprises a variety of sensors. Those of skill in the art will appreciate that the exact number, composition, and arrangement of sensors depends upon the number and type(s) of systems (e.g. security or lighting) and number of lifts that are to be operated by a controller 1. In some instances, multiple controllers may be combined togther. See FIGS. 5 and 6. Thus, some embodiments of the invention include more sensors than other embodiments.

At least one of the sensors of the microcontroller 22 is a height sensor (also referred to herein as a lift height sensor, water pressure sensor, or lift position sensor) that is able to measure the air pressure within the small air hose 6. The air pressure within the small air hose 6 reflects the air pressure within the rigid tube 5 that is coupled (connected) to the small air hose 6. Specifically, the air pressure within the small air tube 6 correlates linearly with changes in the air pressure in the rigid tube 5 as it is raised or lowered in the water. The air pressure within the rigid tube 5 changes as a lift is raised or lowered into water because the rigid tube 5 is simultaneously raised or lowered with the lift. Thus, as the height sensor measures the air pressure within the small air hose 6, the microprocessor 22 uses the sensor's measurements to determine the height (i.e. vertical position) of a lift relative to the surface of the water.

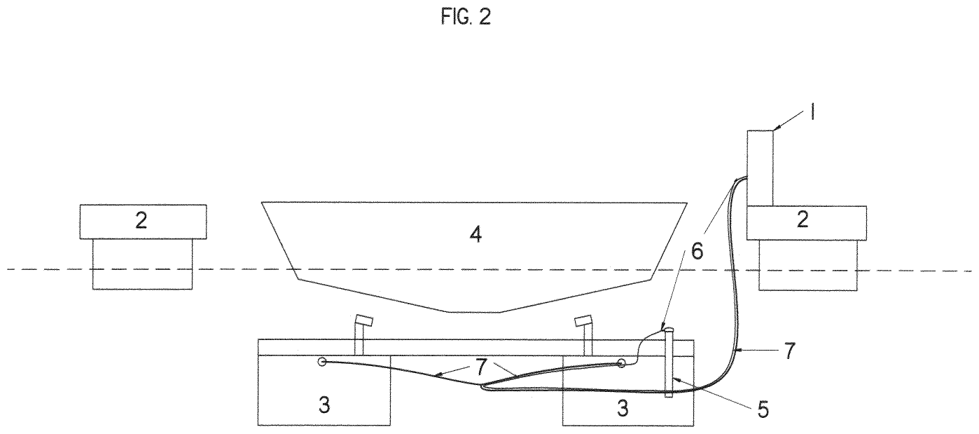

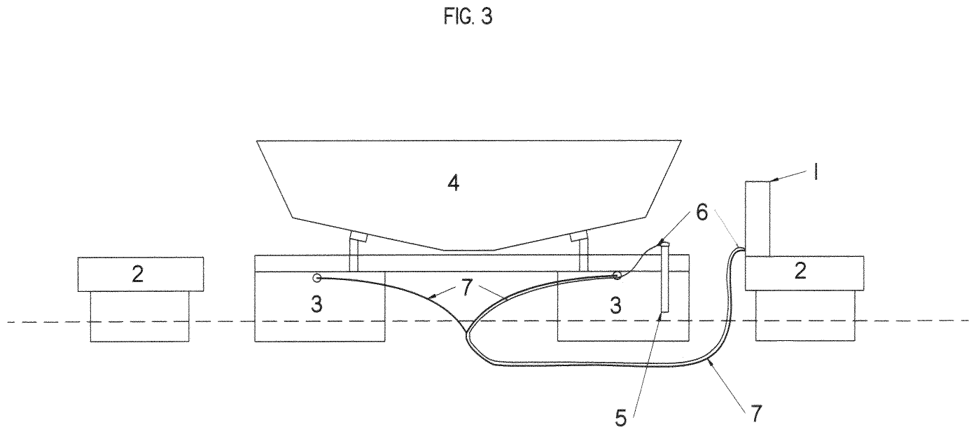

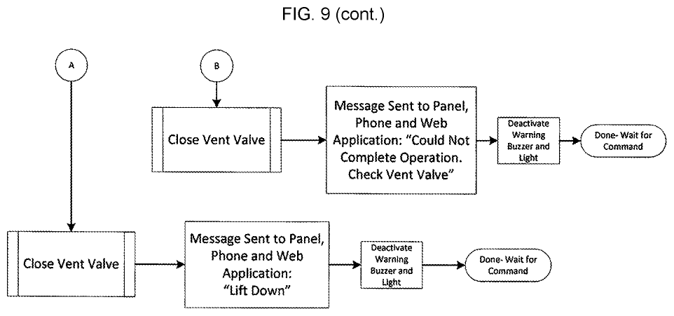

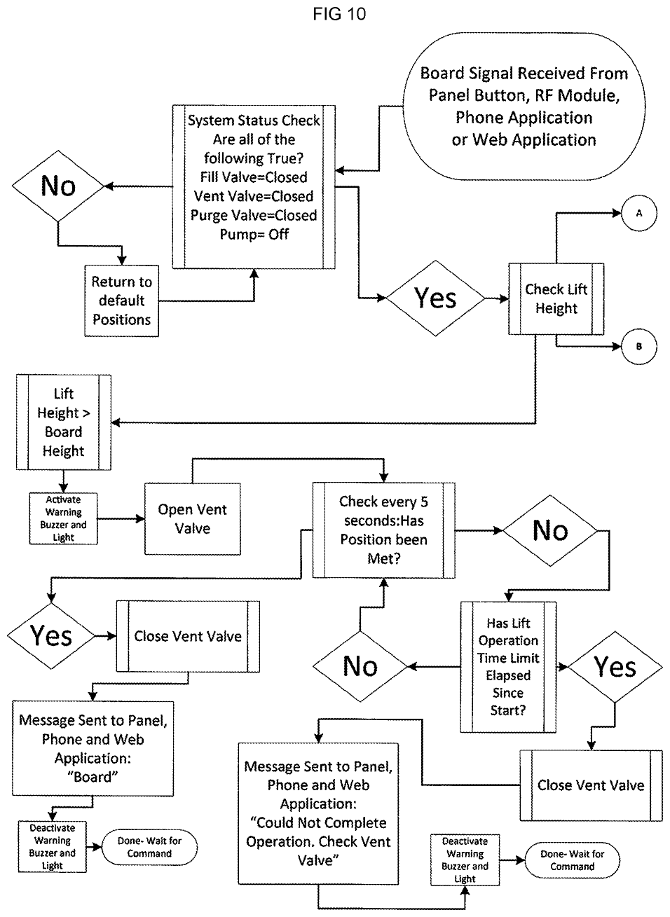

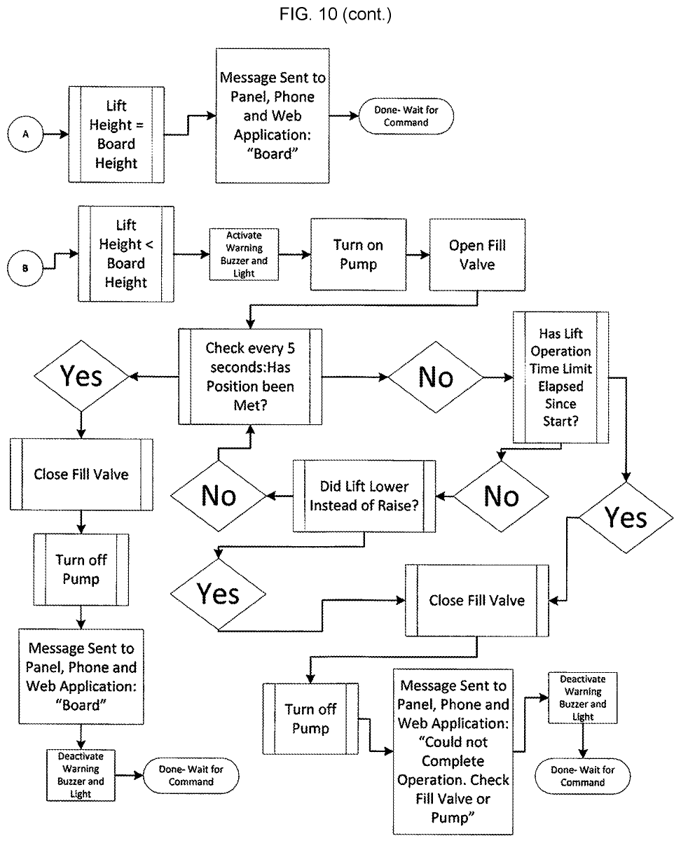

For example, as a lift moves up or down, the rigid tube 5 also moves up or down, respectively, and linear, water pressure changes occur within the rigid tube 5. See FIGS. 1-3 and 8-10 that illustrate the relative position of the rigid tube 5 during boarding (FIGS. 1, 10), operating (i.e. down position) (FIG. 2, 9), and storage (i.e. up position) (FIG. 3, 8) of a lift. As a lift is lowered into the water, the air pressure increases within the rigid tube 5 and the small air tube 6. The height sensor detects the change in air pressure, and the microprocessor 22 within the controller 1 determines that the lift's height relative to the water's surface has lessened. Similarly, as the lift is raised, the air pressure decreases in both the rigid tube 5 and small air hose 6, and the microprocessor 22 detects that the lift's height relative to the water's surface has increased. Thus, the air pressure measured for the lift 3 in the down position illustrated in FIG. 2 is higher than the air pressure measured for the lift 3 in the boarding position illustrated in FIG. 1; and the air pressure measured for the lift 3 in the boarding position (FIG. 1) is higher than the pressure measured for the lift 3 in the up position (FIG. 3).

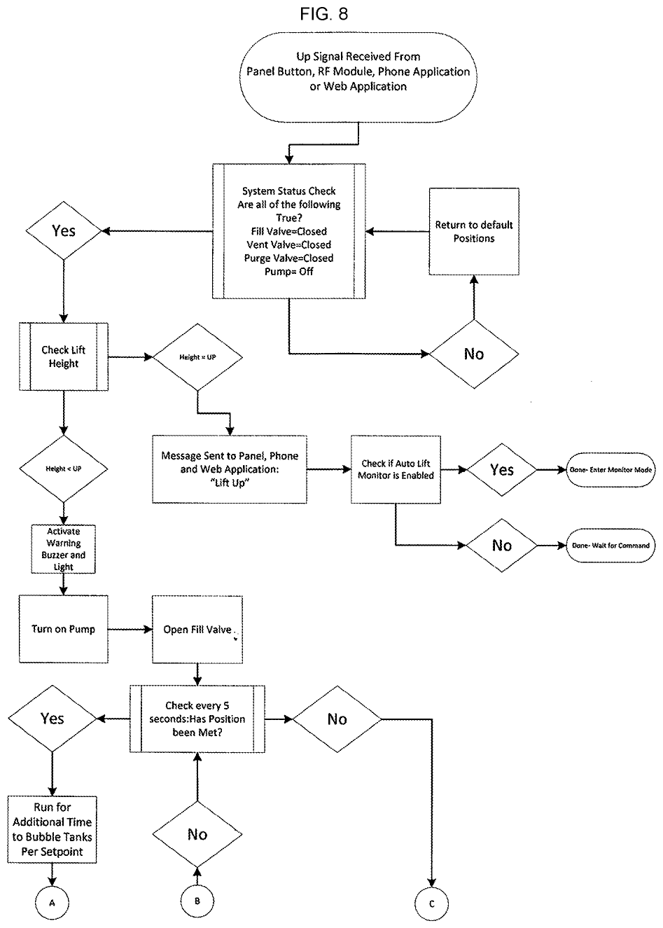

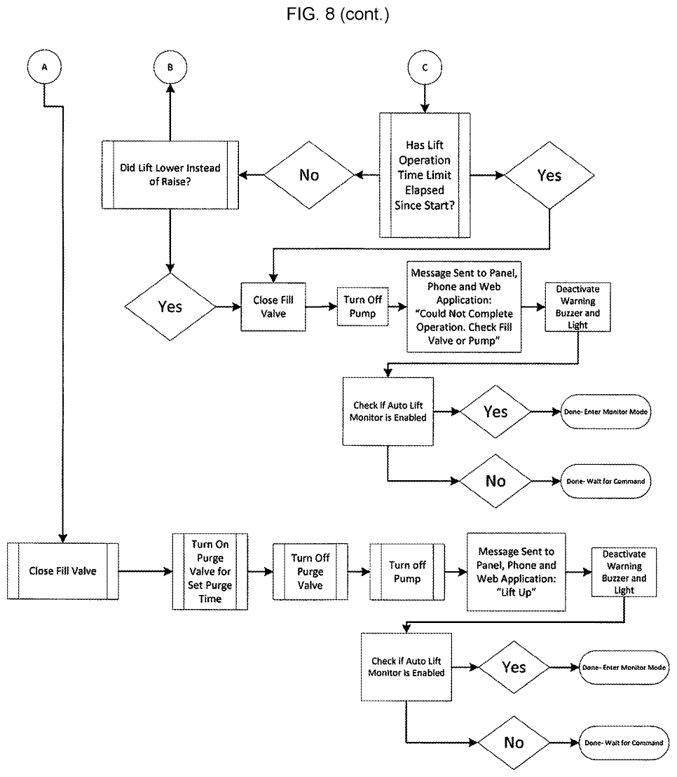

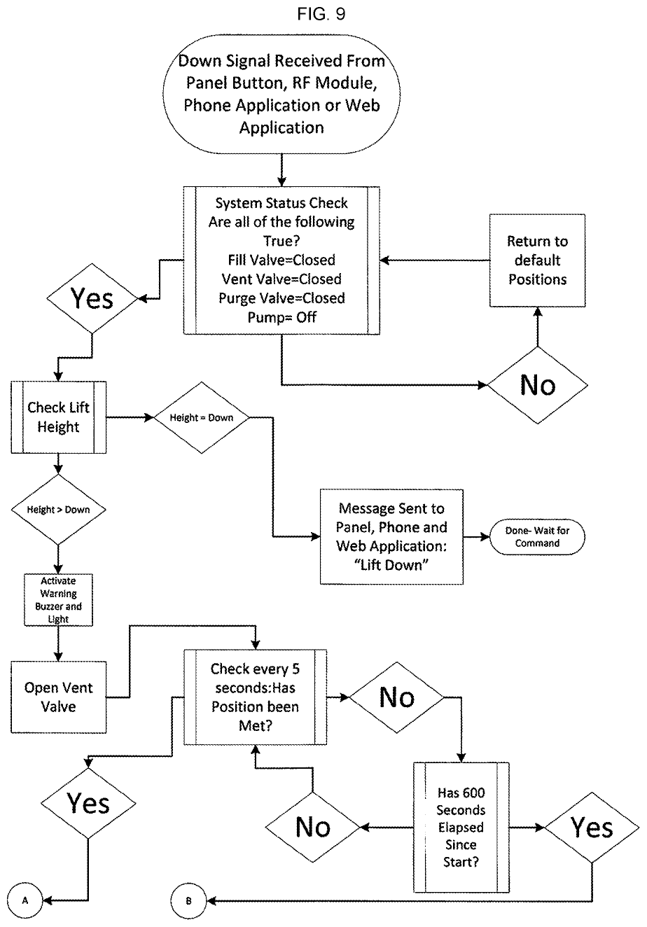

Those of skill in the art will appreciate that any changes in the height of a lift relative to the water's surface can be expressed in any suitable measurement units that a user chooses. Further, a user can program preferred heights for the up, down, and boarding positions into the microprocessor so that an “up” command will cause a lift to rise to a pre-determined position. Similarly, a “down” command will lower a lift to a pre-determined position, and a “boarding” command will adjust a lift's height to that pre-determined position. See FIGS. 8-10.

To reduce, or even eliminate, electrical sensor malfunctions that may be caused by water remaining within the rigid tube 5, the invention provides a means of purging water from the rigid tube 5 after a lift has reached a desired position. To purge any residual water, air from the blower motor 13 (a.k.a. a manifold blower) is forced through the small air hose 6 into the rigid tube 5 after a lift reaches the desired position and before the blower motor 13 is turned off. In most cases it is likely that air needs to be forced through the small air hose 6 into the rigid tube 5 for only a few seconds, but a user may choose to purge the air from the rigid tube 5 for longer.

A directive (command) to force air into the small air hose 6 and rigid tube 5 is programmed into and sent from the controller 1. See FIGS. 8, 10 and 11. When water is to be purged, a signal is sent from the microcontroller 22 to cause a purge solenoid to open a purge valve 14 (i.e. purge solenoid or solenoid valve) so that air flows from the blower motor 13 through a first coupler 25 into a purge hose 23 then through a second coupler 21 into the small air hose 6 and the rigid tube 5. See FIGS. 5, 6, 9 and 10. It will be recognized that the duration and amount of air forced into the rigid tube 5 will vary and depend upon at least the diameters and lengths of the rigid tube 5 and small air hose 6, and amounts of air pressure and air needed to accomplish the desired task. By forcing any residual water from the rigid tube 5, erratic pressure readings caused by residual water left in rigid tube 5 after operation can be eliminated. Advantageously, purging residual water prior to storage is expected to extend the useful lifetime of a pressure sensor as compared to that of a sensor that continues to be exposed to water.

Controllers of the invention include a variety of electrical systems. An exemplary electrical diagram of a lift controller is provided in FIG. 5; exemplary block diagrams of various operations of the lift controller are provided in FIGS. 6 and 8-14. Skilled artisans will appreciate that the types and numbers of electrical systems housed within a controller will depend at least in part upon a user's objectives (e.g. how many lifts and other devices the controller(s) is(are) to operate), as well as, the power source(s) used to energize the controller(s).

The height sensor is a pressure transducer that measures the pressure within the small air hose 6 and is located within the controller 1. The height sensor may measure the pressure continuously or at specified intervals as desired. It sends electrical signals to the microprocessor.

The controller 1 includes a suitable input-output mechanism 9 (e.g. a touchscreen or keyboard) from which a user can enter operating commands and view the current position of a lift and its environment (e.g. relative water level and boat position) and any programmed position changes. Operating commands may be preprogrammed or customized by a user with the input-output mechanism 9.

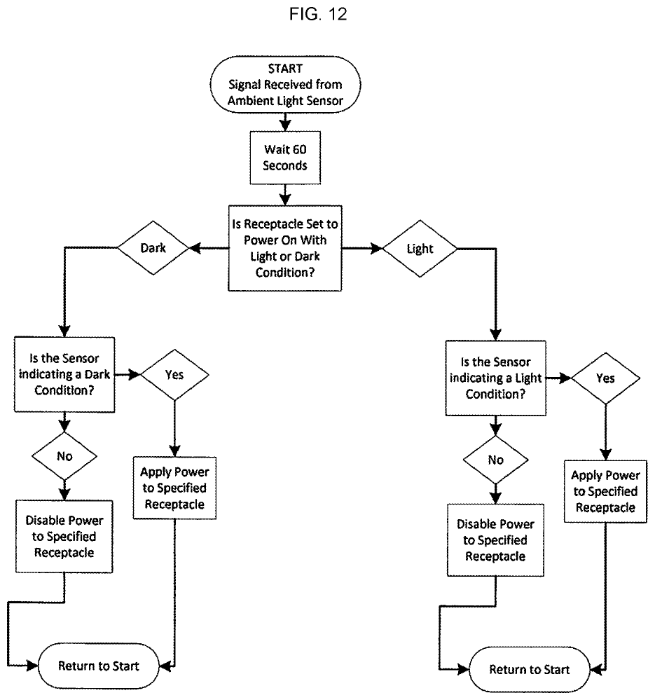

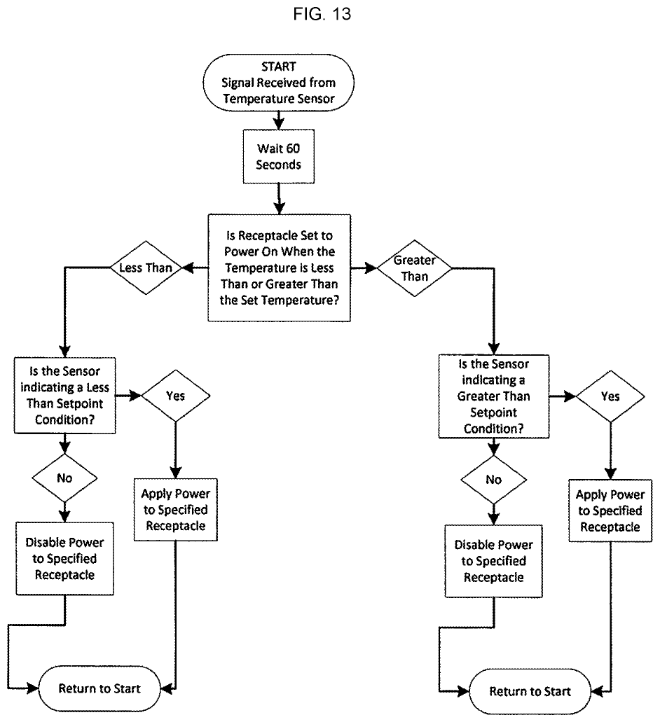

Advantageously, the present invention also monitors changes in air and water temperatures so that a user can determine whether to operate either a dock aerator or deicer that is attached to the system to prevent ice formation that may damage either the lift or adjacent dock. A user can pre-program devices of the invention to power a dock aerator, deicer, other equipment when certain parameters have been met. See for example FIGS. 12 and 13. Temperature sensors for both air and water are attached to the lift, and readings from the sensors are transmitted to the controller. Skilled artisans will appreciate that a variety of suitable temperature sensors are known and may be incorporated into the present invention. All of these sensors can be linked to and operated through the controller 1.

For example, a user selects a “set temperature” at which a dock aerator or deicer should be turned on or off. The microprocessor receives temperature signals from a temperature sensor. As illustrated in FIG. 13, the microprocessor processes the signals that it receives to determine whether it should activate or deactivate the electrical receptacle to which the dock aerator or deicer is attached.

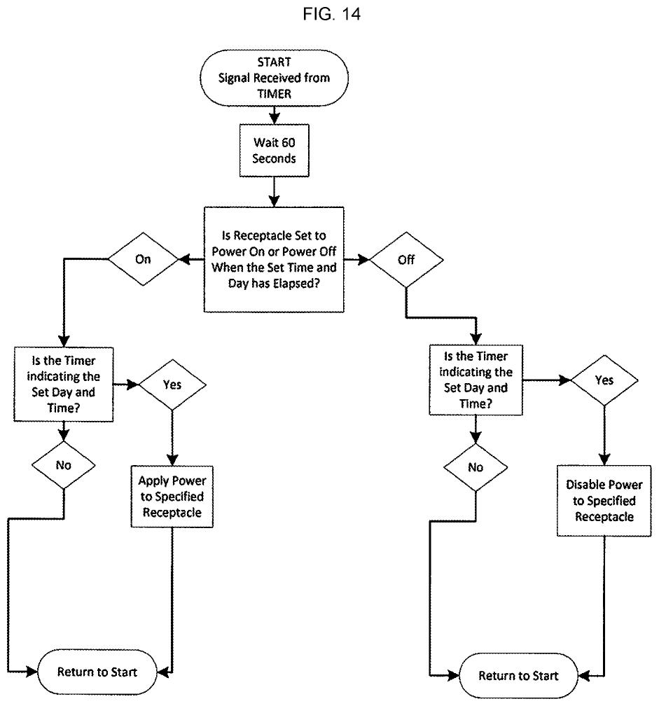

Similarly, systems of the invention can be programmed to control dock lighting. In such systems, an ambient light sensor is present and located either on the lift or associated dock. See FIG. 12. The ambient light sensor transmits data to the controller. Preferably, the connections are wireless, but wired connections may be used. At either a specified light level or time, either preprogrammed or chosen by the user, the controller signals the dock lighting to switch on or off Alternatively, a user may choose to use a set time at which to control the lighting or another system (e.g. security gate, etc.). See FIG. 14.

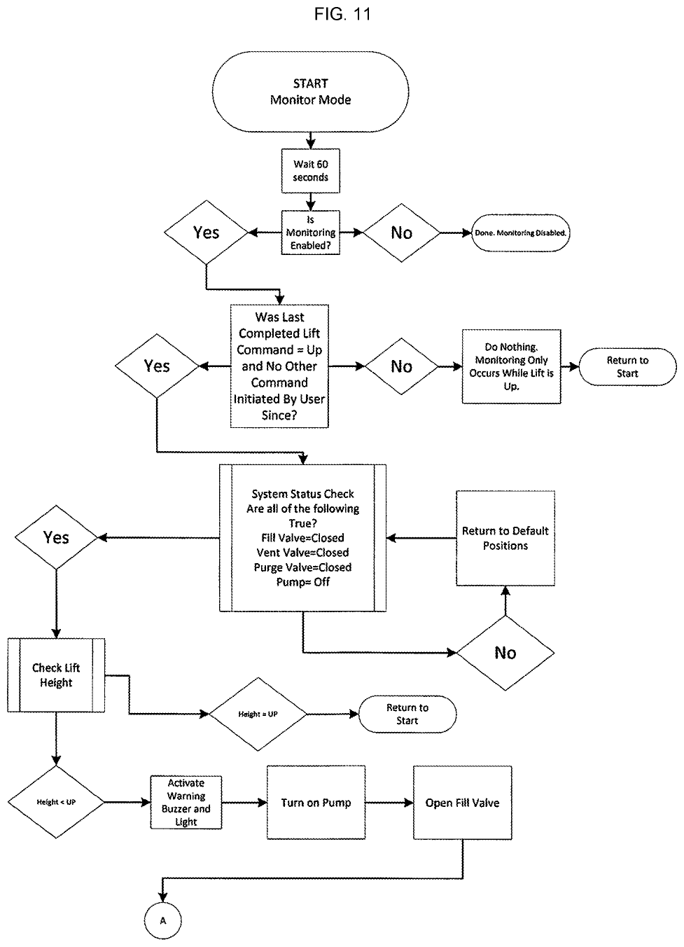

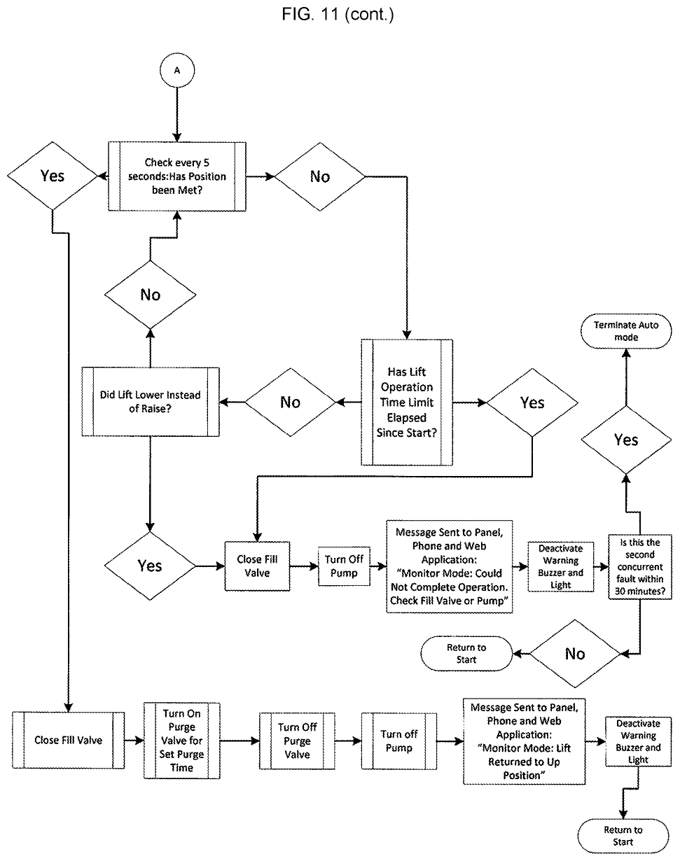

Another improvement of the invention is that the system allows for a lift's position relative to the water level to be monitored and automatically maintained. See FIG. 11. Advantageously, the controller receives data from the lift position sensor. The data may be received either continuously or at specified intervals. The controller is programmed to automatically raise or lower the lift so that the lift's position relative to the water level is maintained. This improvement allows a user to be away from the lift and have confidence that the lift remains in the desired position, most often the up position, so that any watercraft on the lift remains safe, clean, and dry.

The invention provides that a lift's position can be monitored. Data from various sensors are transmitted to the controller. The controller, in turn, can transmit data either directly to a user through a computer interface (e.g. a mobile device application), or alternatively, the user can access the data through a computer (e.g. login to a website). For example, when a system of the invention adjusts a lift's position, either automatically or by manual input, the controller is programmed to notify the user of the adjustment. Notifications can be sent to a user by a variety of means such as a text message, mobile application (app), email, voice message, or other communication means known in the art and selected by the user.

Systems of the invention may include either more or less sensors, or different sensors than are illustrated in FIGS. 5 and 6. The exact composition of and number of sensors in any particular system of the invention will vary with a user's preferences, as well as, the types and numbers of optionally components that may be operated through the controller 1. Similarly, the skilled artisan will appreciate that the number of solid state relays within any particular system of the invention depends upon the number of systems and lifts that a controller is intended to operate. For example, a user may elect to connect the dock aerator or deicer to the controller so that a user can switch the dock aerator or deicer on or off directly through the controller 1.

All systems of the invention will include at least one purge solenoid 14 (i.e. purge valve or solenoid valve) in the controller 1 that, when operating, cause air to be forced into through the small air hose 6 into the rigid tube 5 so that residual water is purged from the rigid tube 5 or debris is pushed away from the rigid tube's open end.

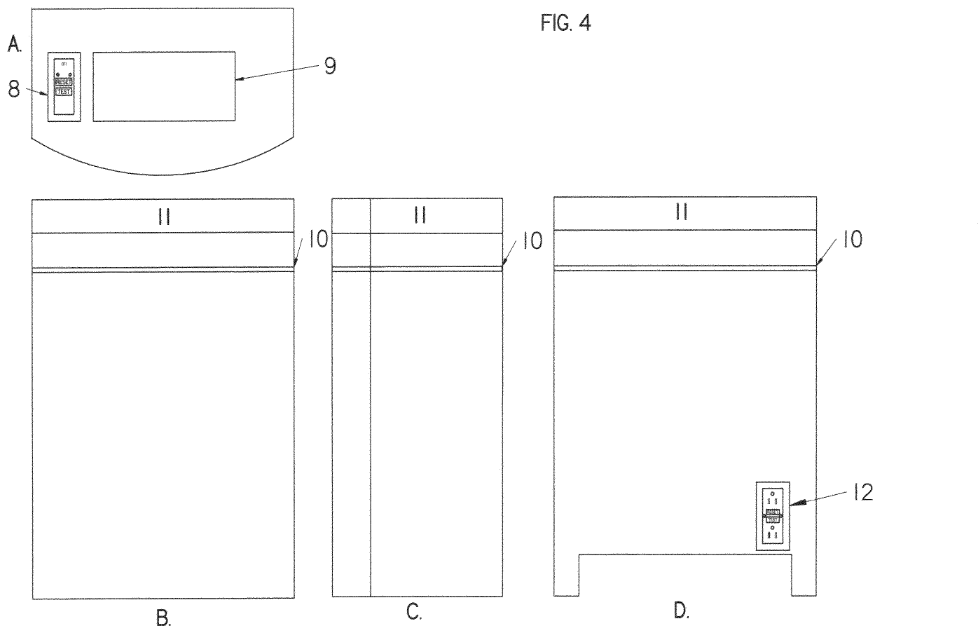

In addition, a user may receive information through the controller interface 9 (see FIG. 4). Those of skill in the art will appreciate that this data can be used to indicate a leak in a lift tank(s) or the need to service the lift. Systems of the invention also include visual and audible alerts, such as a movement warning strobe light, warning buzzer, or other suitable visual and audible alerts known in the art, to indicate that the lift position sensor has detected a change in the lift's position relative to the water level and that corrective action has been or is being taken automatically to return the lift to the preferred, programmed position.

The controller (also referred to herein as a system microcontroller) includes custom programming that processes input from multiple sensors, and based on the analyses of the input, then transmits instructions to activate or inactivate fill valves, exhaust valves, or blower motor(s). The controller processes data (signals) received from any cameras, microphones, or speakers that are linked to a system of the invention. The controller also processes network communications of the invention. As described previously, the controller includes an input-output mechanism by which a user can direct the system. Preferably, the input-output mechanism is a touch screen.

The lift controller is configurable so that multiple blower motors, fill valves and actuators, and exhaust valves can be incorporated into a system of the invention so that the system is compatible with a variety of different types and sizes of pneumatic boatlifts. For lifts or applications that require the use of more than two blower motors, systems of the invention include a secondary slave controller.

Advantageously, when a system of the invention transmits a remote, status update to a user, the system can include either still photographs or video from a camera that is included as part of the controller or from security camera(s) that are linked to the controller and transmit photographs or video to the controller. Thus, systems of the invention can transmit multiple types of data to a user so that the user can be alerted remotely to any movement or operations of the boatlift, as well as, environmental conditions such as air and water temperatures and changes in water levels such as those associated with changes in weather conditions such as storm surge, high wind, heavy rain, etc.

Users may receive remote alerts and status updates by a mobile application (app), website, or through audio alerts. See FIG. 11. The boatlift controller includes a speaker and microphone so that a user may communicate with anyone near the controller, and the controller can transmit audio alerts and status updates to a user remotely.

To improve safety and visibility, the exterior of a controller includes lighting, preferably a LED strip 10, around the circumference of the lift controller enclosure. (See FIG. 4.) Preferably, the lighting will flash when the lift is being operated to alert bystanders. Similarly, the microphone and speaker can be used to provide audible alerts of lift operation to bystanders. The controller includes an onboard alarm (e.g. a buzzer) that sounds briefly before a lift is operated.

Preferably, the controller has a removable lid 11 so that the electronics within the controller can be accessed. In some embodiments, the manual ball valve 16 can be accessed by removing the lid 11. In other embodiments, the manual ball valve 16 is located on the exterior of the controller 1 so that a user can activate it.

In addition, certain embodiments of the controller can include an external electrical socket 12. Preferably a surge protector or analogous device 8 is included in a controller. For example, an electrical socket 12 may be located in the base of the controller, and a surge protector 8 may be located in the lid 9.

Advantageously, in the event a lift jams or there is a large leak in a floating lift, the controller will instruct the blowers to power-off and all valves to shut after a specified period of use (e.g. 15 minutes) when there has been no lift movement detected. In such an event, systems of the invention will notify the user that an error has occurred, and the lift requires service. It is expected that such shutdowns will help to prevent a floating lift from rolling when there is a leak in either a lift tank or air hose.

Systems of the invention include a lift controller having interne and network connection capabilities. Those of skill in the art will appreciate that such capabilities can include Wifi, Wifi hotspots, Ethernet, Bluetooth, cellular network cards, or other technical features known in the art that provide wireless communication capabilities. Preferably, such wireless communications are secure. Controllers of the invention can include unique security identification features that are known in the art so that only authorized users can program and control operations.

Controllers can include programmable power receptacles that can be attached to security systems, lighting, pumps, or other equipment that a user desires to operate from a remote location or to operate when certain conditions occur. Such power receptacles can be scheduled to operate only during specified periods of time or when certain conditions occur. For example, a programmable receptacle may only operate when temperature readings indicate that a deicer that is plugged into the receptacle should operate. Thus, power is only transmitted through wiring that is plugged into the receptacle when the attached equipment is in use so that the risk of electrocution is reduced.

A lift controller includes a battery backup that allows the controller to send a power outage message to the user if the associated dock has lost power for a specified period of time. The user can adjust the specified period of time as appropriate to the conditions.

The controller includes software that interconnects the lift controller hardware with program routines and functions. Those of skill in the art will be familiar with such computer programming functions. Such programming can include the use of an RF transmitter fob or analogous technology to enable a user that is within the range of the RF transmitter to control a lift's position remotely without an internet connection.

Unless defined otherwise, all technical and scientific terms used herein have the same meaning as is commonly understood by one of skill in the art to which this invention belongs at the time of filing. The meaning and scope of terms should be clear; however, in the event of any latent ambiguity, definitions provided herein take precedent over any dictionary or extrinsic definition. Further, unless otherwise required by context, singular terms shall include pluralities and plural terms shall include the singular. Herein, the use of “or” means “and/or” unless stated otherwise. Furthermore, the use of the term “including”, as well as other forms such as “includes” and “included” is not limiting. All patents and publications referred to herein are incorporated by reference herein.

It must be noted that, as used in this specification and the appended claims, the singular forms “a”, “an” and “the” include plural referents unless the content clearly dictates otherwise. All patents and publications referred to herein are incorporated by reference herein.

All of the compositions and methods disclosed and claimed herein can be made and executed without undue experimentation in light of the present disclosure. While the compositions and methods of this invention have been described in terms of preferred embodiments, it will be apparent to those of skill in the art that variations may be applied to the compositions and methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the following claims.

What is claimed is:

1. A boatlift system comprising
a) a controller having an air manifold, a microprocessor having a pressure sensor, and a blower motor that is attached to a first end of a blower hose, wherein the second end of the blower hose is attached to a purge hose, and the microprocessor is attached to a near end of a small air hose that is coupled to the purge hose, and wherein a purge valve is attached to the purge hose between the blower hose and small air hose;
b) an input-output mechanism that is able to transmit and receive a signal; and
c) a rigid tube that is attached vertically to a boatlift or boatlift frame, wherein the rigid tube has an upper end that is sealed and a lower end that is open, and the rigid tube is coupled to the far end of the small air hose, wherein when the boatlift or boatlift frame is lowered into water the open end of the rigid tube is submerged in the water.

2. The boatlift system of claim 1, wherein the microprocessor sends and receives input from the purge valve.

3. The boatlift system of claim 1, wherein a first electric ball valve is attached to the blower hose.

4. The boatlift system of claim 1 further comprising a passive vent hose that is attached to the air manifold.

5. The boatlift system of claim 5, wherein a manual ball valve is attached to the passive vent hose.

6. The boatlift system of claim 1 further comprising an active vent hose that is attached to the air manifold.

7. The boatlift system of claim 7, wherein a second electric ball valve is attached to the active vent hose.

8. The boatlift system of claim 1 further comprising a large air hose that is attached to the air manifold.

9. A method of making a boatlift system comprising
a) constructing a controller having an air manifold, a microprocessor, and a blower motor that is attached to a first end of a blower hose, wherein the second end of the blower hose is attached to a purge hose, and the microprocessor is attached to a near end of a small air hose that is coupled to the purge hose, and wherein a purge valve is attached to the purge hose between the blower hose and small air hose;
b) attaching an input-output mechanism that is able to transmit and receive a signal to the controller; and
c) attaching a rigid tube vertically to a boatlift or boatlift frame, wherein the rigid tube has an upper end that is sealed and a lower end that is open, and the rigid tube is coupled to the far end of the small air hose.

10. The method of making of claim 9, wherein the microprocessor sends and receives input from the purge valve.

11. The method of making of claim 9 further comprising a passive vent hose, an active vent hose, and a large air hose that are attached to the air manifold.

12. The method of making of claim 11, wherein a manual ball valve is attached to the passive vent hose, a first electric ball valve is attached to the blower hose, and a second electric ball valve is attached to the active vent hose.

13. A method of using a boatlift system comprising
a) programming a controller that includes a microprocessor to direct a boatlift or boatlift frame to rise or descend to one or more specified heights relative to a body of water;
b) using a sensor to measure air pressure in a small air hose that has a far end attached to a rigid tube, wherein the rigid tube has a sealed upper end, an open lower end, and is attached vertically to the boatlift or boatlift frame such that when the boatlift or boatlift frame is lowered into the body of water, water enters the open lower end of the rigid tube, and air pressure in the small air hose equals the air pressure within the rigid tube; and
c) operating the controller to raise or lower the boatlift or boatlift frame to a programmed height.

14. The method of using a boatlift system of claim 13 further comprising purging water from the rigid tube by blowing air into the rigid tube through the small air hose, wherein the small air hose has a near end coupled to a blower hose that is connected to a blower such that when the controller directs a purge valve to open, air from the blower is forced through the small air tube into the rigid tube, and any water within the rigid tube is forced from the rigid tube through its lower end.
